(19) United States
(12) Patent Application Publication
(10) Pub. No.: US 2017/0265117 A1
(43) Pub. Date: Sep. 14, 2017

(54) Method for Handover Procedure Enhancement

(71) Applicant: Realtek Semiconductor Corp., HsinChu (TW)

(72) Inventors: Kuang-Yu Yen, Hsinchu County (TW); Yu-Sheng Tang, Miaoli County (TW)

(21) Appl. No.: 15/291,045

(22) Filed: Oct. 11, 2016

(30) Foreign Application Priority Data
Mar. 11, 2016 (TW) 105107452

(51) Int. Cl. H04W 36/38; H04W 40/22; H04W 36/30; H04L 12/26

(52) U.S. Cl. CPC H04W 36/38; H04L 43/16; H04W 40/22; H04W 36/30

(57) ABSTRACT

A method for handover procedure enhancement performed by an access point (AP) of a wireless communication system is provided. The method includes connecting to a mobile device of the wireless communication system, detecting a connection status with the mobile device, and determining whether to transmit a disconnection signal to the mobile device according to the connection status, in which the disconnection signal is configured to request the mobile device to perform a handover procedure.

### BACKGROUND OF THE INVENTION

1. Field of the Invention

The present disclosure relates to a method used in an access point in a wireless communication system, and more particularly, to a method of handover procedure for enhancing quality of wireless connection.

2. Description of the Prior Art

Conventional wireless communication standard IEEE 802.11 does not specify how a wireless station in a wireless local area network performs handover during roaming. Though the recent wireless communication standards, such as IEEE 802.11k and IEEE 802.11r, specify fast handover, pre-authentication, or handover assistant for better connection, the wireless station needs to actively perform handover. Otherwise, these mechanisms, i.e., fast handover, pre-authentication or handover assistant, will not be activated. In addition, based on the conventional handover process, sticky client problem occurs. In detail, the wireless station is roaming in an environment deployed with a plurality of access points, in which the wireless station is away from an original connected access point and approaches to another access point. In this situation, the wireless station continuously connects to the original access point and does not perform handover to the approached access point, which decreases a data rate of the wireless station and affects connection quality.

In the prior art, there is no solution for the sticky client problem. Unless the wireless station triggers the handover, the wireless station performs handover to connect with other access points only if it is far from the original access point and unable to receive wireless signal such that it disconnects with the original access point. For example, due to the unstable connection status, boundary client is in a position that a neighbor access point could be connected, but still transmits wireless packets to the original access point, which decrease transmission performance in the wireless environment.

### SUMMARY OF THE INVENTION

It is therefore an objective to provide a method of handover to solve the sticky client problem and to enhance wireless performance efficiency.

The present disclosure provides a method for handover procedure enhancement performed by an access point (AP) in a wireless communication system. The method includes connecting to a mobile device in the wireless communication system; detecting a connection status with the mobile device; and determining whether to transmit a disconnection signal to the mobile device according to the connection status, in which the disconnection signal is configured to request the mobile device to perform a handover procedure.

The present disclosure further provides a method for handover procedure enhancement performed by an access point (AP) in a wireless communication system. The method includes receiving a packet from a mobile device in the wireless communication system, wherein the mobile device is connected to another AP in the wireless communication system, determining a connection information with the mobile device according to the received packet, and determining whether to transmit a disconnection signal to the mobile device according to the connection information, in which the disconnection signal is configured to request the mobile device to perform a handover procedure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a communication device according to one embodiment of the present disclosure.

FIG. 2 is a flowchart of a process according to one embodiment of the present disclosure.

FIG. 3 is a schematic diagram of a handover procedure according to one embodiment of the present disclosure.

FIG. 4 is a flowchart of a process according to one embodiment of the present disclosure.

FIG. 5 is a schematic diagram of a handover procedure according to one embodiment of the present disclosure.

### DETAILED DESCRIPTION

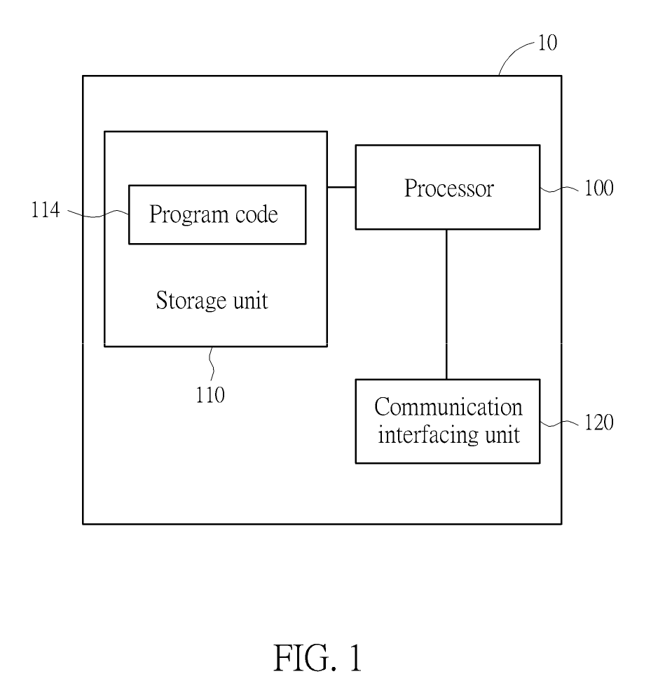

FIG. 1 is a schematic diagram of a communication device 10 according to one embodiment of the present disclosure. The communication device 10 can be a mobile device, e.g., a wireless station, or a wireless network device, e.g., a wireless access point, and includes a processor 100, such as a microprocessor or Application Specific Integrated Circuit (ASIC), a storage unit 110 and a communication interfacing unit 120. The storage unit 110 may be any data storage device that can store a program code 114, for access by the processor 100. Examples of the storage unit 110 include but are not limited to a subscriber identity module (SIM), read-only memory (ROM), flash memory, random-access memory (RAM), CD-ROMs, magnetic tape, hard disk, and optical data storage device. The communication interfacing unit 120 is preferably a radio transceiver and can exchange wireless signals with another network device or mobile device according to processing results of the processor 100.

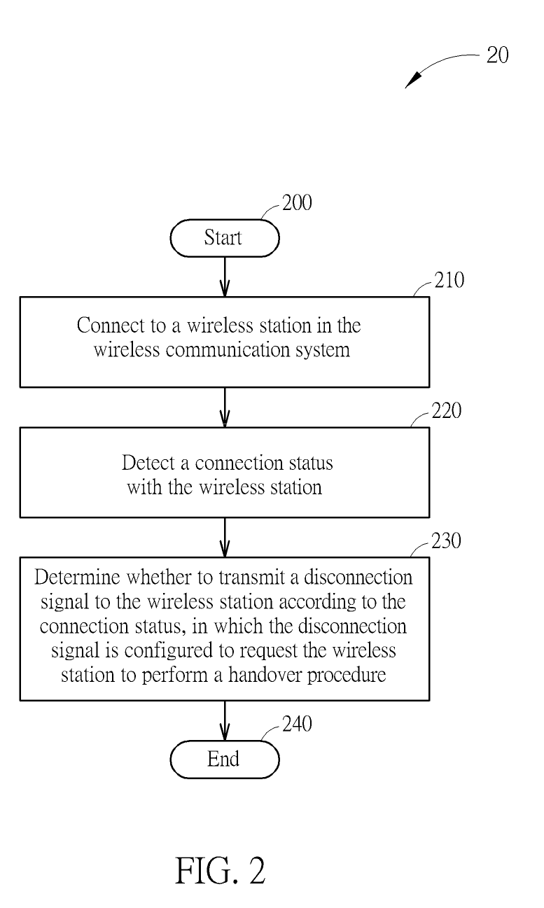

Reference is made to FIG. 2, a flowchart of a process 20 according to one embodiment of the present disclosure is illustrated. The process 20 could be utilized in the communication device 10 of FIG. 1 for triggering handover procedure, so as to increase wireless performance efficiency. In the present embodiment, the communication device is an access point (AP). The process 20 may be compiled into a program code 114 to be stored in the storage unit 110, and may include the following steps:
Step 200: Start.
Step 210: Connect to a wireless station in the wireless communication system.
Step 220: Detect a connection status with the wireless station.
Step 230: Determine whether to transmit a disconnection signal to the wireless station according to the connection status, in which the disconnection signal is configured to request the wireless station to perform a handover procedure.
Step 240: End.

According to the process 20, the AP immediately detects and records the connection status (e.g., signal strength, transmission rate, transmission quality, packet missing ratio and channel occupancy time) with the wireless station after the wireless station connects to the AP, so as to determine distance and transmission quality between the wireless station and the AP. In other words, the AP can determine whether the wireless signal and communication quality with the wireless station is getting weak, to determine whether to send the disconnection message to the wireless station for requesting the wireless station to perform the handover procedure, such that the wireless station is able to connect to another AP.

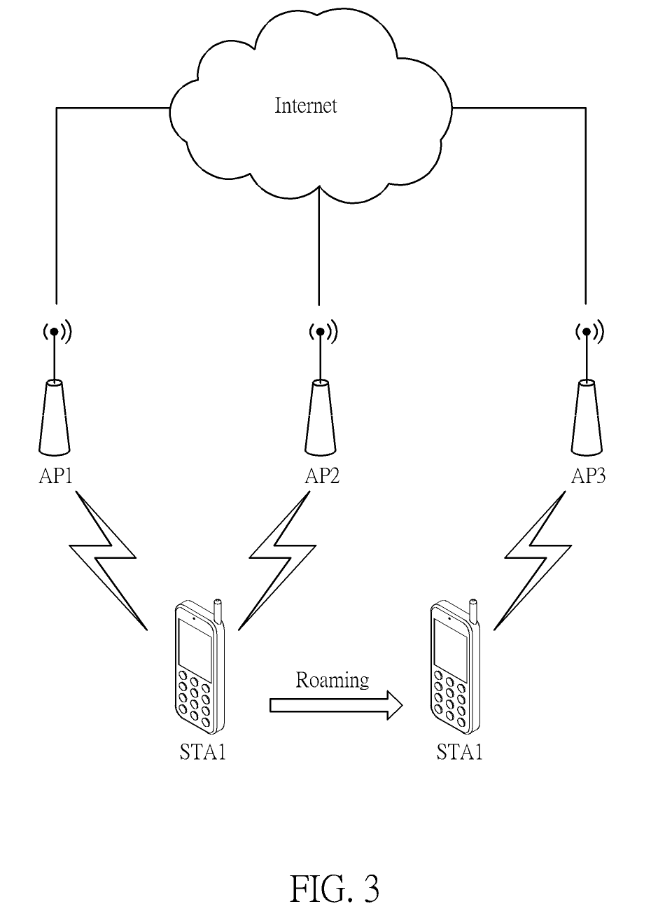

Regarding the operation of the handover procedure, reference is made to FIG. 3. A schematic diagram of a handover procedure according to one embodiment of the present disclosure is illustrated. A wireless communication system shown in FIG. 3 includes a wireless station STA1 and three APs AP1-AP3. The wireless station STA1 first connects to AP1 and moves toward AP2. During the time when the wireless station STA1 moves away from the AP1, wireless signals received by the wireless station STA1 are getting weak. On the other hand, the AP1 detects that the transmission rate and signal strength from the wireless station STA1 are decreased, and starts to determine whether the wireless station STA1 is required to handover to another AP (e.g., whether the transmission rate or signal strength is lower than a threshold), so as to send the disconnection signal to force the wireless station STA1 to handover. In a word, the present disclosure aims at the AP which the wireless station is connected to and is away from, and at analyzing handover timing for the wireless station based on the connection status (e.g., signal strength, packet and transmission rate), so as to solve the sticky client problem.

It should be noted that, an objective of the present disclosure is to solve the problem that the wireless station does not perform handover during roaming in a wireless environment deployed with multiple APs. With the triggering mechanism provided by the present disclosure, the AP can assist the wireless station to perform handover even within an environment in which APs are not produced by the same manufacturer, or the wireless station is a legacy client which does not support handover procedure of the new wireless communication protocol, such as IEEE 802.11K or 802.11R, so as to avoid sticky client problem which decreases wireless performance efficiency (e.g., low transmission rate, high packet loss ratio or long transmission chancel occupancy time).

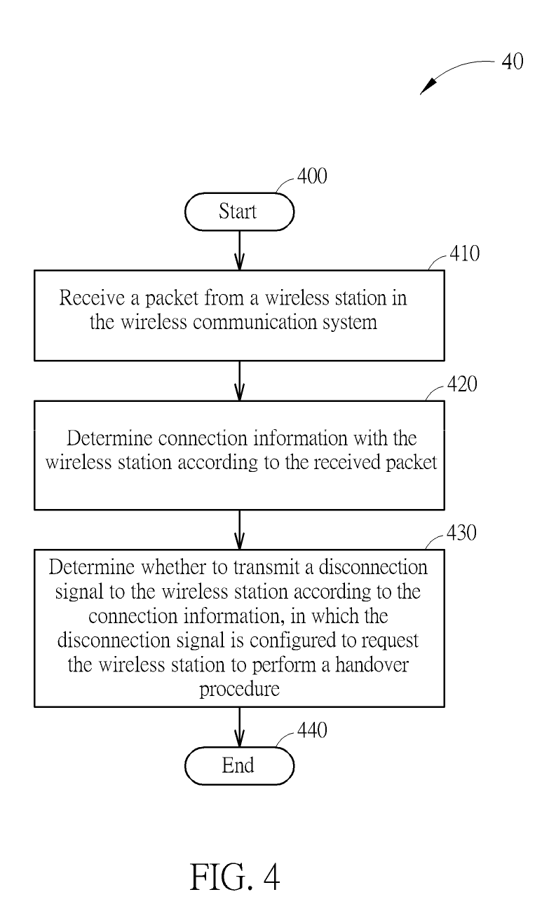

Reference is made to FIG. 4, a flowchart of a process 40 according to one embodiment of the present disclosure is illustrated. The process 40 may be utilized in the communication device 10 of FIG. 1 for triggering handover procedure, to enhance efficiency of the wireless communication system. In this embodiment, the communication device is a base station. The process 40 may be compiled into a program code 114 to be stored in the storage unit 110, and may include the following steps:
Step 400: Start.
Step 410: Receive a packet from a wireless station in the wireless communication system, wherein the wireless station is connected to another AP in the wireless communication system.
Step 420: Determine connection information with the wireless station according to the received packet.
Step 430: Determine whether to transmit a disconnection signal to the wireless station according to the connection information, in which the disconnection signal is configured to request the wireless station to perform a handover procedure.
Step 440: End.

According to the process 40, when connecting to the AP, the wireless station broadcasts connection packet and data packet on a channel corresponding to the AP, and thus the neighbor AP without connection to the wireless station obtains connection information (i.e., distance or signal strength) based on the broadcasted packet. In other words, the neighbor AP determines whether to send a disconnection message, for requesting the wireless station to handover to other AP, according to the distance and signal strength with the wireless station, to prevent the wireless station continuously connecting to the original AP. For example, after the neighbor AP analyzes connection information of the packet, and knows that the signal strength is higher than a threshold or that the wireless station is roaming around, the neighbor AP transmits a disconnection signal to the wireless station, to force the wireless station handover to another AP, in which the connection quality between the another AP and the wireless station is better than the original one.

Reference is made back to FIG. 3. When the wireless station STA1 connects to the AP2 and moves toward the AP3, the AP3 can receive the broadcasted connection packet and data packet from the wireless station STA1, and knows that wireless station STA1 is getting closed to the AP3 but does not connected to the AP3. Therefore, the AP3 sends disconnect signal to the wireless station STA1 for requesting the wireless station STA1 to disconnect and perform handover, so as to achieve the purpose of handover. In a word, the AP closed to but disconnected with the wireless station determines whether to assist the wireless station to perform handover according to the packet received from the wireless station.

Based on those mentioned above, a software manner is adapted for the AP to monitor the wireless station, to analyze the information in the packet received from the wireless station and knows that the wireless station is roaming to a proper place for handover. Thus, the AP can assist the wireless station to handover to another AP, so as to decrease a number of sticky clients and enhance efficiency of the wireless communication system. In addition, by triggering handover via the AP, legacy clients, which do not support latest handover procedure, sticky clients, and boundary clients can handover to a AP with stronger wireless signal as soon as possible, so as to improve the wireless performance. In other words, instead of performing handover until disconnection occurs, the AP forces the wireless station to perform handover procedure at a proper time. Therefore, the roaming wireless station performs handover accordingly, so as to solve the problem of boundary client unstable connection.

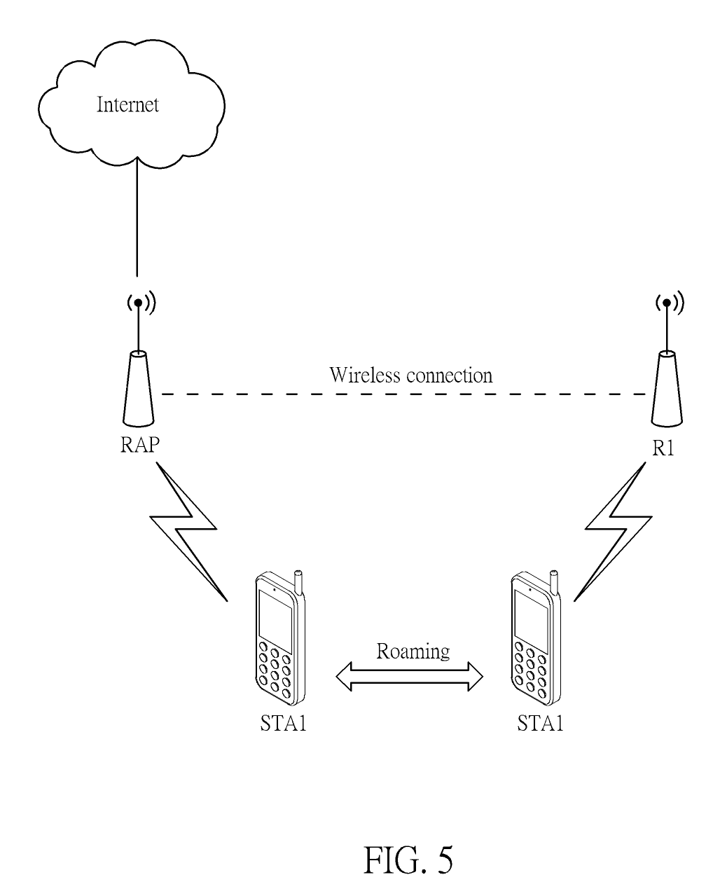

On the other hand, reference is made to FIG. 5, a schematic diagram of a handover procedure according to one embodiment of the present disclosure is illustrated. In this embodiment, the wireless communication system shown in FIG.5 includes an access point RAP, a repeater R1 and a wireless station STA1. The repeater R1 is a signal relay for the AP RAP, with which the wireless station STA1 can connect to the Internet. In addition, the repeater R1 is connected to the Internet without cable. In this situation, sticky client problem still occurs. In detail, the wireless station connects to the AP RAP and then moves toward an area of the repeater R1, but does not perform disconnection to the AP RAP. Thus, the repeater R1 monitors the packet sent from the wireless station STA1 (referring to process 40) or obtains connection status of the wireless station with protocols between the AP RAP and repeater R1 (referring to process 30), and thereby knows where the wireless station should be handover, so as to send the disconnection signal for requesting the wireless station STA1 to disconnect to the AP RAP and perform handover. As such, a handover problem in wireless environment (e.g., an AP in each room of a house) can be solved, where a wireless station roaming between the rooms can handover to a proper AP.

In conclusion, the present disclosure provides a method for the AP to request the roaming wireless station to disconnect with the AP, and further assist the wireless station to perform the handover to connect to a better AP. As such, the problem of sticky client away from the AP but still connecting to the AP is solved with the present invention, so as to avoid decreasing connection quality and affecting wireless performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handover procedure enhancement, performed by an access point (AP) in a wireless communication system, the method comprising:
connecting to a mobile device in the wireless communication system;
detecting a connection status with the mobile device; and
determining whether to transmit a disconnection signal to the mobile device according to the connection status, in which the disconnection signal is configured to request the mobile device to perform a handover procedure.

2. The method of claim 1, wherein the connection status comprises at least one of signal strength, transmission rate, transmission quality and packet missing rate.

3. The method of claim 2, wherein the step of determining whether to transmit the disconnection signal to the mobile device according to the connection status comprises:
transmitting the disconnection signal to the mobile device if detecting that the signal strength, the transmission rate or the transmission quality is lower than a first threshold, and/or if the packet missing rate is higher than a second threshold.

4. The method of claim 1, wherein the AP is a wireless repeater.

5. A method for handover procedure enhancement, performed by an access point (AP) in a wireless communication system, the method comprising:
receiving a packet from a mobile device in the wireless communication system, wherein the mobile device is connected to another AP in the wireless communication system;
determining a connection information with the mobile device according to the received packet; and
determining whether to transmit a disconnection signal to the mobile device according to the connection information, in which the disconnection signal is configured to request the mobile device to perform a handover procedure.

6. The method of claim 5, wherein the packet is a connection packet or a data packet.

7. The method of claim 5, wherein the connection information comprises a distance between the mobile device and the AP, and/or signal strength information between the mobile device and the AP.

8. The method of claim 7, wherein the step of determining whether to transmit the disconnection signal to the mobile device according to the connection information comprises:
transmitting the disconnection signal to the mobile device if the distance between the mobile device and the AP is lower than a first threshold, and/or if the signal strength is higher than a second threshold.
